(19) United States
(12) Patent Application Publication
(10) Pub. No.: US 2012/0052868 A1
(43) Pub. Date: Mar. 1, 2012

(54) WIRELESS COMMUNICATION METHOD, WIRELESS COMMUNICATION SYSTEM, BASE STATION APPARATUS, AND PORTABLE TERMINAL

(75) Inventors: Tetsuo TOMITA, Kawasaki (JP); Bun KIMURA, Kawasaki (JP)

(73) Assignee: FUJITSU LIMITED, Kawasaki-shi (JP)

(21) Appl. No.: 13/292,503

(22) Filed: Nov. 9, 2011

Related U.S. Application Data
(63) Continuation of application No. PCT/JP2009/002183, filed on May 18, 2009.

(51) Int. Cl. H04W 16/24

(52) U.S. Cl. 455/447

(57) ABSTRACT

In a wireless communication system, a cell region managed by each base station includes a first region within the cell region, and a second region surrounding the first region. Frequency bands used in the first and second regions are different. The base stations use a common frequency band and a common communication channel in respective second regions when establishing communication. When the base stations makes a downlink communication with the portable terminal located in the second region, communication data including communication control information is distributed to neighboring base stations, When making an uplink communication, the base station receives the communication data including the communication control information, transferred from the neighboring base stations.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2009/002183 filed on May 18, 2009, in the Japanese Patent Office, the disclosure of which is hereby incorporated by reference.

### FIELD

The present invention relates to a cellular wireless communication method and wireless communication system that use a plurality of base station apparatuses and portable terminals, and to a base station apparatus and a portable terminal used in such a cellular wireless communication method and wireless communication system.

### BACKGROUND

The mobile communication technique is making a transition from the 2nd generation mobile communication system, including PDC (Personal Digital Cellular), GSM (Global System for Mobile communications) and the like, to the 3G (Generation) or 3.5G mobile communication system, including W-CDMA (Wideband-Code Division Multiple Access) and the like. It is expected that communication services using the 3.9G (or 3G Evolution) mobile communication system, including Super 3G and the like, may start in the future. Due to such progress in the mobile communication technique, high-speed, large-capacity communications have been realized. For example, the communication rate (or speed) for the 3G mobile communication system is 384 Kbps for the downlink and 64 Kbps for the uplink, and the communication rate greatly improves for the 3.9G mobile communication system in which the downlink rate is 300 Mbps and the uplink rate is 75 Mbps.

When considering a method of allocating a frequency band and a communication channel for each portable terminal as in the case of the 2G mobile communication system, the width of the frequency band obtained for the entire system may be determined from a product of the frequency bandwidth allocated to one portable terminal and the number of portable terminals. The throughput of the apparatus in the system may be determined from a product of the communication rate of the portable terminal and the number of portable terminals. Due to the increase in the frequency bandwidth, the increase in the number of portable terminals, and the increase in the communication rate of the portable terminal which are likely to occur in the future, the increase in the width of the frequency band and the increase in the throughput of the apparatus in the system may be unavoidable. For this reason, under the restrictions of limited communication resources in the system, it may be difficult to greatly increase the width of the frequency band and to greatly increase the throughput of the apparatus in the system.

On the other hand, in the 3G mobile communication system, it becomes difficult for radio waves to reach end parts within a cell region, and thus, the communication rate may deteriorate and the handover may occur frequently. In order to cope with such a problem, the 3G mobile communication system employs a branch communication system in which a channel called a branch is set for each base station apparatus located in a neighborhood of the portable terminal, the same data is communicated in the set channel, and the data correctly arriving at the base station apparatus is selected and received.

FIG. 1 is a simplified diagram for explaining a branch wireless communication system. A base station apparatus BS1 that manages a cell #1 determines a branch #1 between this base station apparatus BS1 and a portable terminal PT, determines a branch #2 between the base station apparatus BS1 and the portable terminal PT via a base station apparatus BS2 that manages an adjacent cell #2, and determines a branch #3 between the base station apparatus BS1 and the portable terminal PT via a base station apparatus BS3 that manages an adjacent cell #3.

FIG. 2 is a block diagram illustrating an example of the base station apparatus. A base station apparatus 100 illustrated in FIG. 2 includes a network interface terminating part (NWIF terminating part) 102, a protocol terminating and resource managing part (PRC/RES managing part) 104, a wireless communication part 110, an inter-base station communication part (I-BS communication part) 112, and a control part 114.

Under the management and control of the control part 114, the NWIF terminating part 102 performs a communication with an apparatus of a communication network in a higher level (or layer), such as a RNC (Radio Network Controller), and the PRC/RES managing part 104 manages the communication protocol and generates data corresponding to a physical channel format based on data sent from the NWIF terminating part 102. The generated data are sent to the portable terminal as communication data, via the branch (or channel) that is set. The communication data are sent to the portable terminal via the wireless communication part 110 or, the I-BS communication part 112 (using the branch).

The branch communication system may improve the communication quality at the end part of the cell region. However, because a plurality of frequency bands and channels are allocated to one portable terminal, the required frequency band and throughput increase considerably. For this reason, it may be difficult to greatly increase the width of the frequency band and to further improve the throughput of the apparatuses in the system, using the branch communication system having limited communication resources.

On the other hand, in the 3.5G mobile communication system, such as the HSDPA (High-Speed Downlink Packet Access) and the HSUPA (High-Speed Uplink Packet Access), that is extended from the 3G mobile communication system, the frequency bands and the communication channels may be used in common among a plurality of portable terminals.

For example, a Japanese Laid-Open Patent Publication No. 2002-64848 proposes the following mobile communication system in order to improve the throughput of the mobile communication.

That is, in the proposed mobile communication system, the terminal of each zone communicates via the base station, and the base station is arranged in each of the zones that are provided so that each zone has at least one adjacent zone with a mutually overlapping area. A central control station is connected to each base station, and controls the communication between each terminal and the base station of the zone covering the terminal. The central control station includes a schedule creating part to create a connection schedule for specifying one or a plurality of base stations to which the terminal is to link, based on the traffic of the base stations in the zones covering the terminals, and sends block data to the terminal separately for each of the one or the plurality of base stations determined by the connection schedule.

According to this proposed mobile communication system, the channel capacity of each of the base stations may be utilized efficiently, and the throughput of each of the terminals may be improved. Hence, the mobile communication system may send a large amount of data, such as image data, within a short time even at the end part of the cell region. The connection schedule created by the schedule creating part may be used to specify one or a plurality of base stations to which the terminal is to link, but the communication between the specified base station and the terminal is performed using a different frequency channel. For this reason, it may be difficult to considerably increase the frequency channels in the proposed mobile communication system using limited communication resources.

### SUMMARY

Accordingly, it is an object in one aspect of the embodiment to provide a cellular wireless communication method, a cellular wireless communication system, a base station apparatus, and a portable terminal, that may improve the communication quality at the end part of the cell region using limited communication resources.

According to one aspect of the present invention, there is provided a cellular wireless communication method using a plurality of base station apparatuses and a portable terminal, wherein a cell region managed by each of the plurality of base station apparatuses includes a first region within the cell region, and a second region surrounding the first region and adjacent to another cell region that is adjacent to the cell region, wherein the plurality of base station apparatuses use a common frequency band and a common communication channel in respective second regions when communicating with the portable terminal, and the cellular wireless communication method includes generating communication data including, as communication control information, identification information of the portable terminal at a sending destination and identification information of at least one base station apparatus communicatable with the portable terminal, when an arbitrary base station apparatus amongst the plurality of base station apparatuses communicates with the portable terminal located in the second region within the cell region that is managed by the arbitrary base station apparatus; distributing the communication data from the arbitrary base station apparatus to at least one base station apparatus communicatable with the portable terminal, depending on the communication control information; receiving at least two communication data by the portable terminal by performing a communication between the portable terminal and the arbitrary base station apparatus and between the portable terminal and the at least one base station apparatus to which the communication data is distributed; and processing each of the at least two communication data received by the portable terminal as data having the portable terminal as the sending destination, depending on the communication control information included in each of the at least two communication data.

According to one aspect of the present invention, there is provided a cellular wireless communication method using a plurality of base station apparatuses and a portable terminal, wherein a cell region managed by each of the plurality of base station apparatuses includes a first region within the cell region, and a second region surrounding the first region and adjacent to another cell region that is adjacent to the cell region, wherein the plurality of base station apparatuses use a common frequency band and a common communication channel in respective second regions when communicating with the portable terminal, and the cellular wireless communication method includes sending from the portable terminal communication data including, as communication control information, identification information of an arbitrary base station apparatus managing the cell region in which the portable terminal is located, when the portable terminal is located within the second region of the cell region managed by the arbitrary base station apparatus; receiving, by the arbitrary base station apparatus, the communication data from the portable terminal and the communication data received by and transferred from a neighboring base station apparatus located in a neighborhood of the arbitrary base station apparatus based on the communication control information; and processing the communication data received from the portable terminal and the communication data transferred from the neighboring base station apparatus as data to be sent from the portable terminal and having the arbitrary base station apparatus as the sending destination, depending on the communication control information included in the communication data received from the portable terminal and the communication data transferred from the neighboring base station apparatus.

According to one aspect of the present invention, there is provided a cellular wireless communication system including a plurality of base station apparatuses and a portable terminal, wherein a cell region managed by each of the plurality of base station apparatuses includes a first region within the cell region, and a second region surrounding the first region and adjacent to another cell region that is adjacent to the cell region, wherein each of the plurality of base station apparatuses includes a first communication part configured to communicate with the portable terminal using a common frequency band and a common communication channel in respective second regions of the cell regions managed by the plurality of base station apparatuses; a first processing part configured to generate communication data including, as communication control information, identification information of the portable terminal at a sending destination and identification information of a neighboring base station apparatus located in a neighborhood of the base station apparatus managing the cell region and communicatable with the portable terminal, when the base station apparatus communicates with the portable terminal located in the second region within the cell region that is managed thereby; and an inter-base station communication part configured to distribute the communication data to the neighboring base station apparatus communicatable with the portable terminal, depending on the communication control information, wherein the portable terminal includes a second communication part configured to receive at least two communication data by performing a communication between the portable terminal and the base station apparatus at a distributing source that distributes the communication data by the inter-base station communication part, and between the portable terminal and the neighboring base station apparatus at a distributing destination; and a second processing part configured to process each of the at least two communication data received by the portable terminal as data having the portable terminal as the sending destination, depending on the communication control information included in each of the at least two communication data.

According to one aspect of the present invention, there is provided a cellular wireless communication system including a plurality of base station apparatuses and a portable terminal, wherein the portable terminal includes a storage part configured to store identification information of a base station apparatus that manages a cell region in which the portable terminal is located; and a first communication part configured to send communication data including the identification information of the base station apparatus as communication control information, wherein the cell region managed by each of the plurality of base station apparatuses includes a first region within the cell region, and a second region surrounding the first region and adjacent to another cell region that is adjacent to the cell region, wherein each of the plurality of base station apparatuses includes a second communication part configured to use a common frequency band and a common communication channel in respective second regions of the cell regions managed by the plurality of base station apparatuses when communicating with the portable terminal; an inter-base station communication part configured to receive the communication data received by and transferred from a neighboring base station apparatus located in a neighborhood of the base station apparatus that manages the cell region based on the communication control information included in the communication data, when the portable terminal is located within the second region of the cell region managed by the base station apparatus and sends the communication data; and a second processing part configured to process the communication data received by the second communication part and the communication data transferred from the neighboring base station apparatus and received by the inter-base station communication part, as data to be sent from the portable terminal and having the base station apparatus as a sending destination, depending on the communication control information included in the communication data received by the second communication part and the communication data received by the inter-base station communication part, when the portable terminal is located within the second region of the cell region managed by the base station apparatus and sends the communication data.

According to one aspect of the present invention, there is provided a base station apparatus in a cellular wireless communication system including a plurality of base station apparatuses and a portable terminal, wherein a cell region managed by each of the plurality of base station apparatuses includes a first region within the cell region, and a second region surrounding the first region and adjacent to another cell region that is adjacent to the cell region, the base station apparatuses including a communication part configured to communicate with the portable terminal using a common frequency band and a common communication channel in respective second regions of the cell regions managed by the plurality of base station apparatuses; a processing part configured to generate communication data including, as communication control information, identification information of the portable terminal at a sending destination and identification information of a neighboring base station apparatus located in a neighborhood of the base station apparatus managing the cell region and communicatable with the portable terminal, when the base station apparatus communicates with the portable terminal located in the second region within the cell region that is managed thereby; and an inter-base station communication part configured to distribute the communication data depending on the communication control information in order to send the communication data from the neighboring base station apparatus to the portable terminal.

According to one aspect of the present invention, there is provided a base station apparatus in a cellular wireless communication system including a plurality of base station apparatuses and a portable terminal, wherein the cell region managed by each of the plurality of base station apparatuses includes a first region within the cell region, and a second region surrounding the first region and adjacent to another cell region that is adjacent to the cell region, the base station apparatus including a communication part configured to use a common frequency band and a common communication channel in respective second regions of the cell regions managed by the plurality of base station apparatuses; an inter-base station communication part configured to receive the communication data received by and transferred from a neighboring base station apparatus located in a neighborhood of the base station apparatus that manages the cell region based on the communication control information included in the communication data, when the portable terminal is located within the second region of the cell region managed by the base station apparatus and sends the communication data; and a processing part configured to process the communication data received by the communication part and the communication data transferred from the neighboring base station apparatus and received by the inter-base station communication part, as data to be sent from the portable terminal and having the base station apparatus as a sending destination, depending on the communication control information included in the communication data received by the communication part and the communication data received by the inter-base station communication part, when the portable terminal is located within the second region of the cell region managed by the base station apparatus and sends the communication data.

According to one aspect of the present invention, there is provided a portable terminal in a cellular wireless communication system including a plurality of base station apparatuses and the portable terminal, wherein a cell region managed by each of the plurality of base station apparatuses includes a first region within the cell region, and a second region surrounding the first region and adjacent to another cell region that is adjacent to the cell region, wherein the plurality of base station apparatuses use a common frequency band and a common communication channel in respective second regions when communicating with the portable terminal, the portable terminal including a communication part configured to receive using the wireless communication system, when the portable terminal is located within the second region of the cell region managed by an arbitrary base station apparatus, communication data sent from the arbitrary base station apparatus and including, as communication control information, identification information of the portable terminal at a sending destination and identification information of at least one base station apparatus communicatable with the portable terminal, and communication data, including the communication control information, distributed from the arbitrary base station apparatus to a neighboring base station apparatus located in a neighborhood of the arbitrary base station apparatus and sent from the neighboring base station apparatus; and a processing part configured to process each of the communication data sent from the arbitrary base station apparatus and the communication data sent from the neighboring base station apparatus having the portable terminal as the sending destination, depending on the communication control information included in each of the communication data sent from the arbitrary base station apparatus and the communication data sent from the neighboring base station apparatus.

According to one aspect of the present invention, there is provided a portable terminal in a cellular wireless communication system including a plurality of base station apparatuses and the portable terminal, wherein a cell region managed by each of the plurality of base station apparatuses includes a first region within the cell region, and a second region surrounding the first region and adjacent to another cell region that is adjacent to the cell region, wherein the plurality of base station apparatuses use a common frequency band and a common communication channel in respective second regions when communicating with the portable terminal, the portable terminal including a storage part configured to store identification information of an arbitrary base station apparatus that manages the cell region in which the portable terminal is located; and a communication part configured to send, using the wireless communication system, communication data including the identification information of the arbitrary base station apparatus as communication control information to the arbitrary base station apparatus and a neighboring base station apparatus located in a neighborhood of the arbitrary base station apparatus, when the portable terminal is located in the second region of the cell region managed by the arbitrary base station apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a simplified diagram for explaining a branch wireless communication system;

FIG. 2 is a block diagram illustrating an example of the base station apparatus;

FIG. 3 is a diagram for explaining cell regions of a wireless communication system in one embodiment of the present invention;

FIGS. 4A and 4B respectively are block diagrams illustrating an example of a general structure of a base station apparatus and a portable terminal in the wireless communication system illustrated in FIG. 3;

FIGS. 5A through 5C respectively are diagrams illustrating protocol structures used in the portable terminal, neighboring base station apparatuses, and a serving base station apparatus;

FIG. 6 is a diagram illustrating an example of a data format of additional header information of the communication protocols illustrated in FIGS. 5A through 5C;

FIGS. 7A and 7B respectively are diagrams for explaining timing information used in the wireless communication system illustrated in FIG. 3;

FIGS. 8A and 8B respectively are diagrams for explaining scheduling information used in the wireless communication system illustrated in FIG. 3;

FIG. 9 is a diagram for explaining a radio wave intensity at the end part of the cell region in the wireless communication system illustrated in FIG. 3;

FIG. 10 is a flow chart for explaining a downlink flow between the serving base station apparatus and the portable terminal in the wireless communication system illustrated in FIG. 3;

FIGS. 11A through 11C respectively are diagrams for explaining an example of the downlink flow in the wireless communication system illustrated in FIG. 3;

FIGS. 12A and 12B respectively are diagrams for explaining another example of the downlink flow in the wireless communication system illustrated in FIG. 3;

FIGS. 13A through 13D respectively are diagrams for explaining a change in a distributing destination of communication data in the wireless communication system illustrated in FIG. 3;

FIG. 14 is a flow chart for explaining an uplink flow between the serving base station apparatus and the portable terminal in the wireless communication system illustrated in FIG. 3;

FIG. 15 is a diagram for explaining an example of the uplink flow in the wireless communication system illustrated in FIG. 3;

FIGS. 16A through 16E respectively are diagrams illustrating a change of the serving base station apparatus due to moving of the portable terminal in the wireless communication system illustrated in FIG. 3; and

FIGS. 17A and 17B respectively are diagrams for explaining the radio wave intensity in the wireless communication system illustrated in FIG. 3.

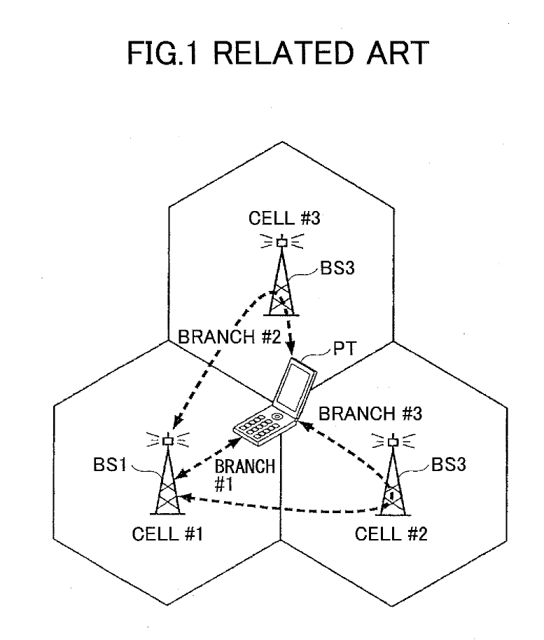

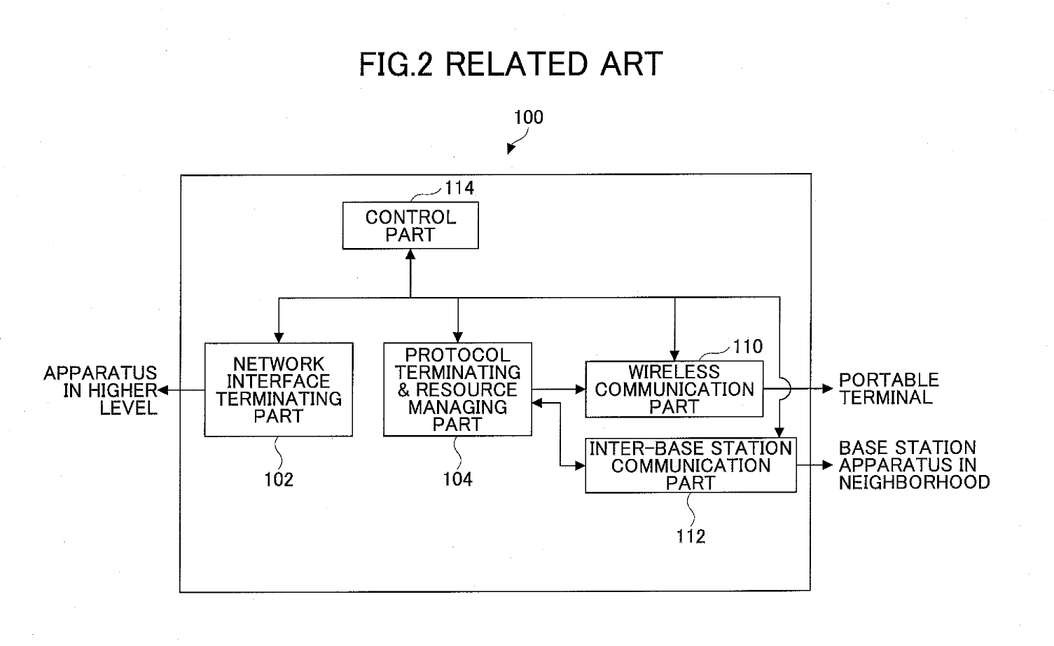

### DESCRIPTION OF EMBODIMENTS

Preferred embodiments of the present invention will be described with reference to the accompanying drawings.

A description will now be given of a wireless communication method, a wireless communication system, a base station apparatus, and a portable terminal in each embodiment according to the present invention.

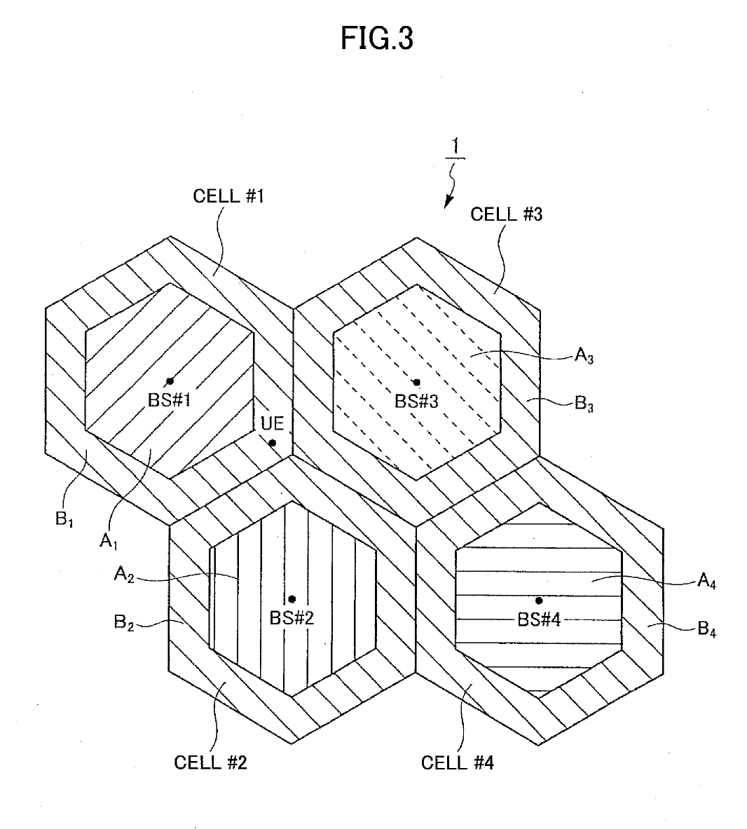

FIG. 3 is a diagram for explaining cell regions of a wireless communication system in one embodiment of the present invention.

A wireless communication system (hereinafter also simply referred to as a “system”) is a cellular wireless communication system in one embodiment of the present invention. The wireless communication system 1, at an end part of each cell region, adjacent to neighboring cell regions, communicates with a portable terminal at a frequency band different from that used for the communication within a cell region. In this state, a common frequency band and a common communication channel (or physical channel) are used between base station apparatuses. Further, communication data that are sent includes, as communication control information, identification information of a sending destination and a sending source. Hence, the communication quality at the end part of the cell region may be improved using limited communication resources.

FIG. 3 illustrates base station apparatuses BS#1, BS#2, BS#3, and BS#4. In this example, a portable terminal (or user equipment) UE is located within a cell region #1 that is managed by the base station apparatus BS#1.

[Cell Region]

The base station apparatuses BS#1 through BS#4 manage cell regions (hereinafter also referred to as “cells”) #1 through #4, respectively. The cells #1 through #4 may respectively be segmented into first regions A₁ through A₄, and second regions B₁ through B₄ surrounding the first regions A₁ through A₄ and adjacent to neighboring cells. A first frequency band used for the communication between each of the first regions A₁ through A₄ and the portable terminal UE is different from a second frequency band used for the communication between each of the second regions B₁ through B₄ and the portable terminal UE. In addition, the second frequency band is used in common (or shared) among the base station apparatuses BS#1 through BS#4, and the communication channel (or physical channel) is used in common (or shared) among the base station apparatuses BS#1 through BS#4, when communicating with the portable terminal UE.

The first frequency bands used in the first regions A1 through A4 of the cells #1 through #4 differ among the cells #1 through #4. The communication performed in the second regions B₁ through B₄ between the base station apparatuses BS#1 through BS#4 and the portable terminal UE uses the single common physical channel. In other words, when the portable terminal UE is located within the second regions B₁ through B₄, the portable terminal UE is communicatable with the base station apparatus that manages the cell in which the portable terminal UE is located, and the portable terminal UE is also communicatable with the base station apparatus that manages the neighboring cell. Because the communication performed in the second regions B₁ through B₄ between the base station apparatuses BS#1 through BS#4 and the portable terminal UE uses the single common physical channel, communications are performed on the common physical channel when a plurality of portable terminals are located in the second regions B₁ through B₄.

Accordingly, the frequency bandwidth may be used widely by sharing the frequency band for the communication in the second regions B₁ through B₄, and thus, a high-speed communication may be performed. In addition, while the second frequency band is shared in the second regions B₁ through B₄, the first frequency bands used in the first regions A₁ through A₄ are allocated to be different among the cells #1 through #4, and consequently, the number of portable terminals accommodatable within the cells #4 through #4 may be increased considerably.

[Structure of Base Station Apparatus]

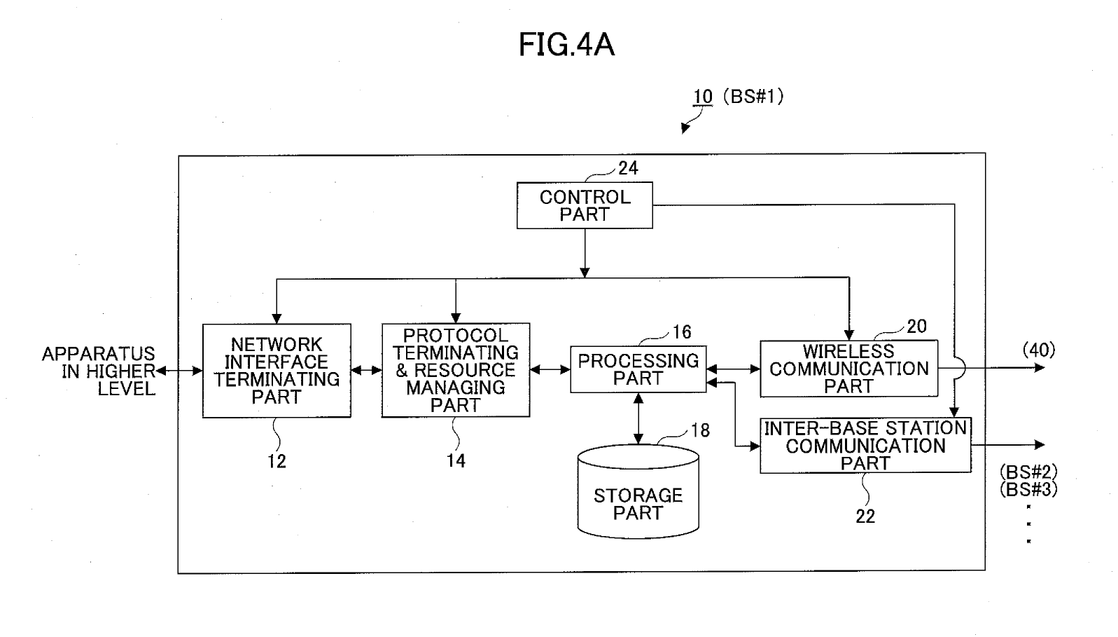

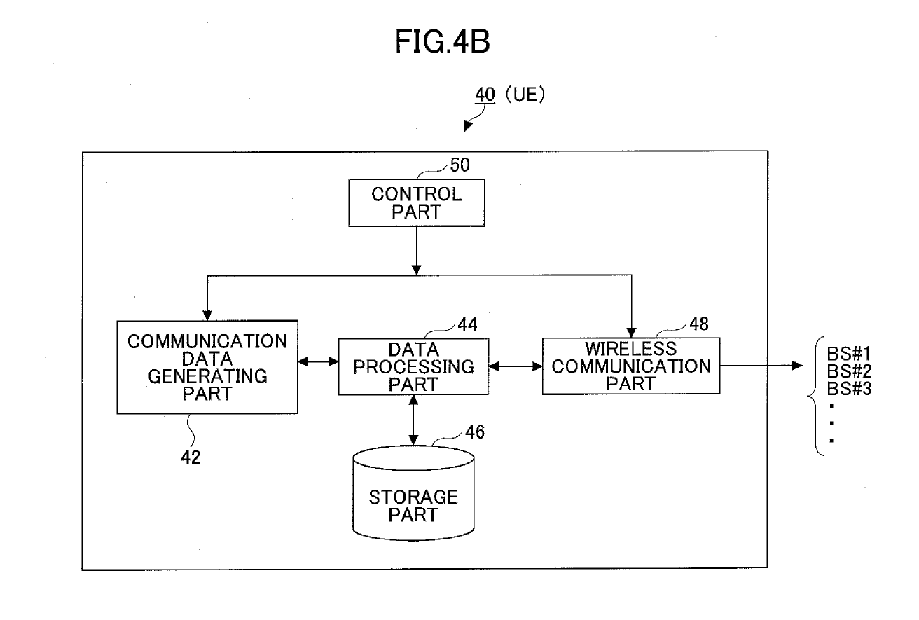

FIGS. 4A and 4B respectively are block diagrams illustrating an example of a general structure of the base station apparatus and the portable terminal in the wireless communication system illustrated in FIG. 3.

FIG. 4A illustrates the general structure of the base station apparatus BS#1, as an example. The base station apparatuses BS#2 through BS#4 have the same structure as the base station apparatus BS#1, and description and illustration thereof will be omitted.

A base station apparatus 10 illustrated in FIG. 4A includes a network interface terminating part (NWIF terminating part) 12, a protocol terminating and resource managing part (PRC/RES managing part) 14, a processing part 16, a storage part 18, a wireless communication part 20, an inter-base station communication part (I-BS communication part) 22, and a control part 24.

The NWIF terminating part 12 communicates with an apparatus of a communication network in a higher level (or layer), such as a RNC (Radio Network Controller), using a predetermined communication protocol.

PRC/RES managing part 14 manages the communication protocol and generates data corresponding to a format of the wireless communication protocol, based on data sent from the NWIF terminating part 12. The PRC/RES managing part 14 also generates data corresponding to a format of a protocol of the communication network in the higher level, based on the data corresponding to the format of the wireless communication protocol.

The processing part 16 performs the following data processings (a) through (c).

In the case of the downlink communication, the data processing (a) generates communication data by including the generated data in the communication control information.

In the case of the downlink communication, the data processing (b) acquires identification (BS-Add: BS address) of the base station apparatus that is located in a neighborhood and is communicatable with the portable terminal UE.

In the case of the uplink communication, the data processing (c) determines whether the communication data sent from the portable terminal UE and received by the base station apparatus has this base station apparatus as the sending destination, using the communication control information, and performs a predetermined process depending on the determination result.

The communication control information used in the data processing (a) includes the identification information (UE-id) of the portable terminal UE that is the sending destination, and the identification information (BS-Add) of the base station apparatus that is the sending source. The communication control information may include at least one of timing information indicating send timings of the plurality of base station apparatuses, and scheduling information indicating subcarrier allocation information of the plurality of base station apparatuses.

The timing information may be a wireless frame number, for example, that determines the send timing of each base station apparatus. The send timings of the plurality of base station apparatuses may be synchronized using the wireless frame number. The scheduling information may identify a subcarrier allocation pattern that indicates the subcarrier to be used when the wireless carrier is divided into subcarriers.

The data processing (b) acquires the identification information (BS-Add) of the base station apparatus communicatable with the portable terminal UE, and stores (or records) the acquired identification information of the communicatable base station apparatus in the storage part 18.

As will be described later, when the base station apparatus manages the portable terminal UE located within the cell, this base station apparatus establishes a connection with the portable terminal UE, and thereafter sends confirmation data, including the identification information (BS-Add) thereof, to the portable terminal UE. When the portable terminal UE returns the confirmation data sent thereto to the base station apparatus, the communicatable base station apparatuses communicatable with the portable terminal UE and located in the neighborhood may also receive the confirmation data. The base station apparatus in the neighborhood transfers the confirmation data received to the base station apparatus at the sending destination, and thus, the processing part 16 may acquire the identification information (BS-Add) of the communicatable base station apparatus communicatable with the portable terminal UE.

The data processing (c) determines whether the base station apparatus is the sending destination of the communication data sent or transferred from the portable terminal UE, based on the communication control information included in the communication data. The base station apparatus performs a process to synthesize (or combine) or, to select one of, the communication data transferred from the communicatable base station apparatuses located in the neighborhood and the communication data received by itself.

The storage part 18 stores and retains the communication control information that is included in the communication data and is acquired by the processing part 16. The storage part 18 stores the identification information (BS-Add) of the base station apparatus thereof, the identification information (UE-Id) of the portable terminal UE at the sending destination obtained by the communication with the portable terminal UE, the identification information (BS-Add) of the base station apparatus at a distributing destination, the timing information, and the scheduling information. The identification information (BS-Add) of the base station apparatus at the distributing destination is stored in the form of a table in a related manner to the identification information (UE-Id) of the portable terminal UE.

The wireless communication part 20 generates RF (Radio Frequency) signals using the communication data, and sends the RF signals to the portable terminal UE. In the first regions A₁ through A₄, the wireless communication part 20 communicates using the first frequency band that is determined for each base station apparatus. In the second regions B₁ through B₄, the wireless communication part 20 communicates using the second frequency band that is used in common among the base station apparatuses located in the neighborhood. Hence, the wireless communication part 20 includes an antenna apparatus that is configured to enable the communication using the first frequency band and communication using the second frequency. Because the communication in the first regions A₁ through A₄ is performed using the first frequency band that is determined for each base station apparatus, and the communication in the second regions B₁ through B₄ is performed using the second frequency band that is different from the first frequency band, a handover is made when the portable terminal UE moves between one of the first regions A₁ through A₄ and a corresponding one of the second regions B₁ through B₄. This handover is, however, is made within the cell in which the communication power is relatively large, and not at the end part of the cell. For this reason, the deterioration of the communication rate and the frequent handover, which may occur in the conventional system, may be avoided according to this embodiment.

The I-BS communication part 22 communicates with the base station apparatuses located in the neighborhood. For example, the I-BS communication part 22 is used when performing a downlink communication to the portable terminal UE at the sending destination by distributing the communication data to the communicatable base station apparatuses located in the neighborhood, and when performing an uplink communication to the serving base station apparatus that manages the cell in which the portable terminal UE is located by receiving the communication data transferred from the communicatable base station apparatus located in the neighborhood.

The control part 24 controls the operation of, and manages, each of the NWIF terminating part 12, the PRC/RES managing part 14, the wireless communication part 20, and the I-BS communication part 22.

[Structure of Portable Terminal]

FIG. 4B illustrates the general structure of the portable terminal UE. A portable terminal (UE) 40 illustrated in FIG. 4B includes a communication data generating part 42, a data processing part 44, a storage part 46, a wireless communication part 48, and a control part 50.

The communication data generating part 42 generates the data corresponding to the format of the wireless communication protocol, from data generated according to user's manual input and the like of the portable terminal 40.

The data processing part 44 performs the following data processings (d) and (e).

In the case of the uplink communication, the data processing (d) generates the communication data by adding additional header information (Additional Hdr) to the data generated by the communication data generating part 42. The additional header information (Additional Hdr) includes the identification information (Serving BS-Add) of the serving base station apparatus that manages the cell in which the portable terminal UE is located, and the identification information (UE-Id) of the portable terminal UE.

In the case of the downlink communication, the data processing (e) determines whether the communication data sent from the portable terminal UE has this portable terminal UE as the sending destination, using the communication control information included in the communication data, and performs a predetermined process depending on the determination result. For example, when it is determined that the communication data received by the portable terminal UE has this portable terminal UE as the sending destination, the portable terminal UE performs a process to synthesize (or combine) or, to select one of, the communication data transferred from the communicatable base station apparatuses located in the neighborhood and the communication data received from the serving base station apparatus.

The storage part 46 stores the communication control information. The storage part 46 also stores the identification information (UE-id) of the portable terminal UE itself, and the identification information (Serving BS-Add) of the serving base station apparatus.

The wireless communication part 48 generates RF (Radio Frequency) signals using the communication data, and sends the RF signals to the serving base station apparatus at the sending destination. In the first regions A₁ through A₄, the wireless communication part 48 communicates using the first frequency band that is determined for each base station apparatus. In the second regions B₁ through B₄, the wireless communication part 48 communicates using the second frequency band that is used in common among the base station apparatuses located in the neighborhood. Hence, the wireless communication part 48 includes an antenna apparatus that is configured to enable the communication using the first frequency band and communication using the second frequency. A handover between one of the first regions A₁ through A₄ and a corresponding one of the second regions B₁ through B₄ is requested with respect to the serving base station apparatus when the radio wave intensity in the first regions A₁ through A₄ or the radio wave intensity in the second regions B₁ through B₄ exceeds a predetermined level.

The control part 50 controls the operation of, and manages, each of the communication data generating part 42 and the wireless communication part 48.

[Communication Protocol]

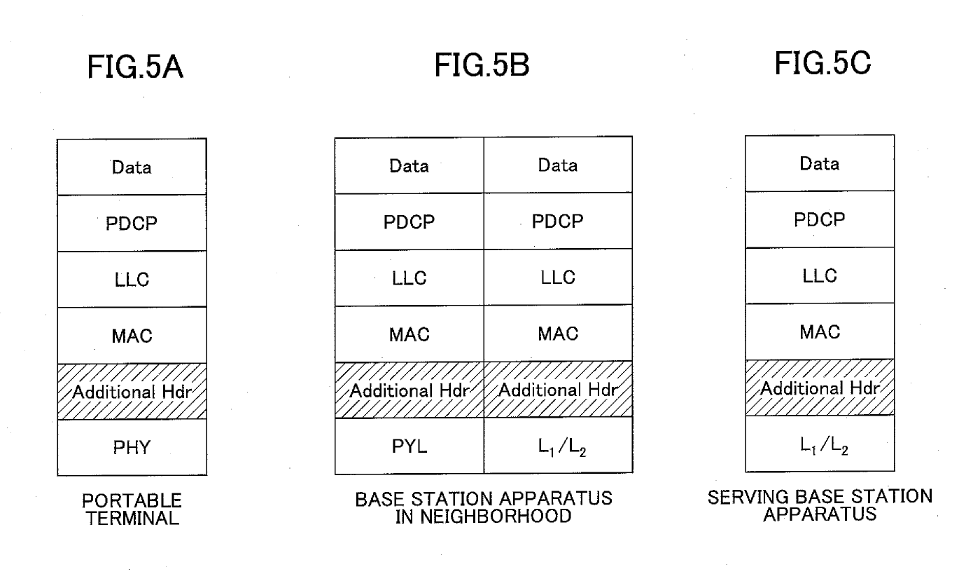

FIGS. 5A through 5C respectively are diagrams illustrating protocol structures used in the portable terminal, the neighboring base station apparatuses, and the serving base station apparatus.

As illustrated in FIGS. 5A through 5C, the communication protocol includes a physical layer (PHY) or a layer 1/2 (L1/L2), a media access control (MAC), a logic link control (LLC), and a packet data convergence protocol (PDCP). In addition, the communication control information, that is to be added as the additional header information (Additional Hdr) of the communication data, is added between the physical layer (PHY) or the layer 1/2 (L1/L2) and the media access control (MAC).

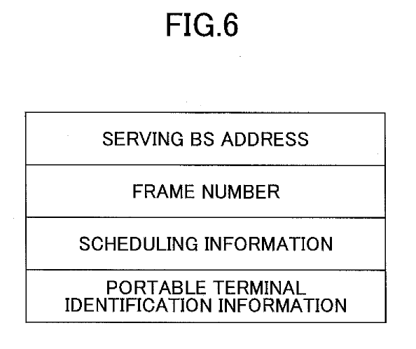

FIG. 6 is a diagram illustrating an example of a data format of the additional header information (Additional Hdr) of the communication protocols illustrated in FIGS. 5A through 5C. In the data format illustrated in FIG. 6, the additional header information (Additional Hdr) determines the identification information or address (Serving BS-Add) of the serving base station apparatus, the send timing information or the wireless frame number, the scheduling information indicating the subcarrier allocation pattern, and the identification information (UE-id) of the portable terminal UE.

[Timing Information]

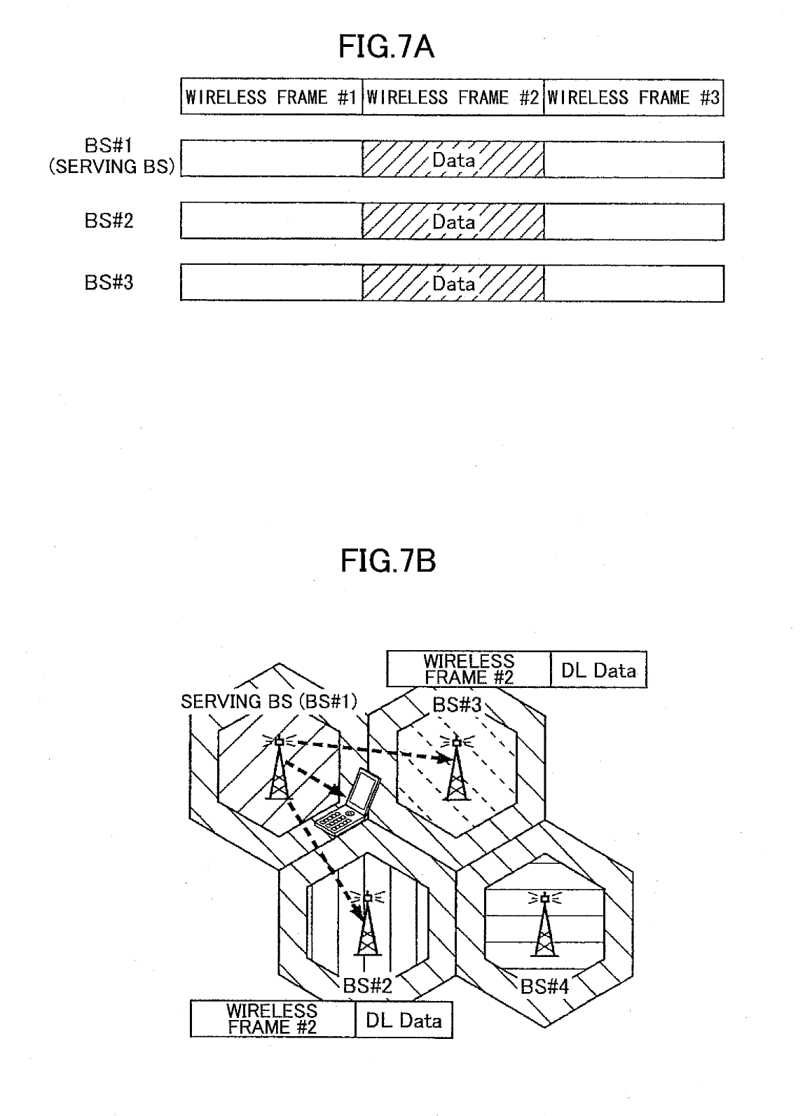

FIGS. 7A and 7B respectively are diagrams for explaining the timing information used in the wireless communication system illustrated in FIG. 3. As illustrated in FIG. 7B, it is assumed for the sake of convenience that the portable terminal UE is located within the second region B₁ of the serving base station apparatus BS#1. In this case, when the serving base station apparatus BS#1 makes a downlink communication to the portable terminal UE via the base station apparatuses BS#2 and BS#3 located in the neighborhood, the communication data (DL Data) is distributed to the base station apparatuses BS#2 and BS#3, and the communication data (DL Data) is sent via the base station apparatuses BS#2 and BS#3. In this state, the send timings of the communication data (DL Data) from the base station apparatuses BS#2 and BS#3 may be matched by matching the wireless frame numbers, as illustrated in FIG. 7A. In other words, the send timings of the communication data (DL Data) from the base station apparatuses BS#2 and BS#3 may be synchronized. In this example, the send timings may be synchronized by matching the wireless frame number to be “#2”. The wireless frame number is included within the additional header information (Additional Hdr) of the communication data (DL Data). Hence, the base station apparatuses BS#2 and BS#3 may use the additional header information (Additional Hdr) included within the communication data (DL Data) in order to synchronize the send timings to the send timing of the serving base station apparatus BS#1.

[Scheduling Information]

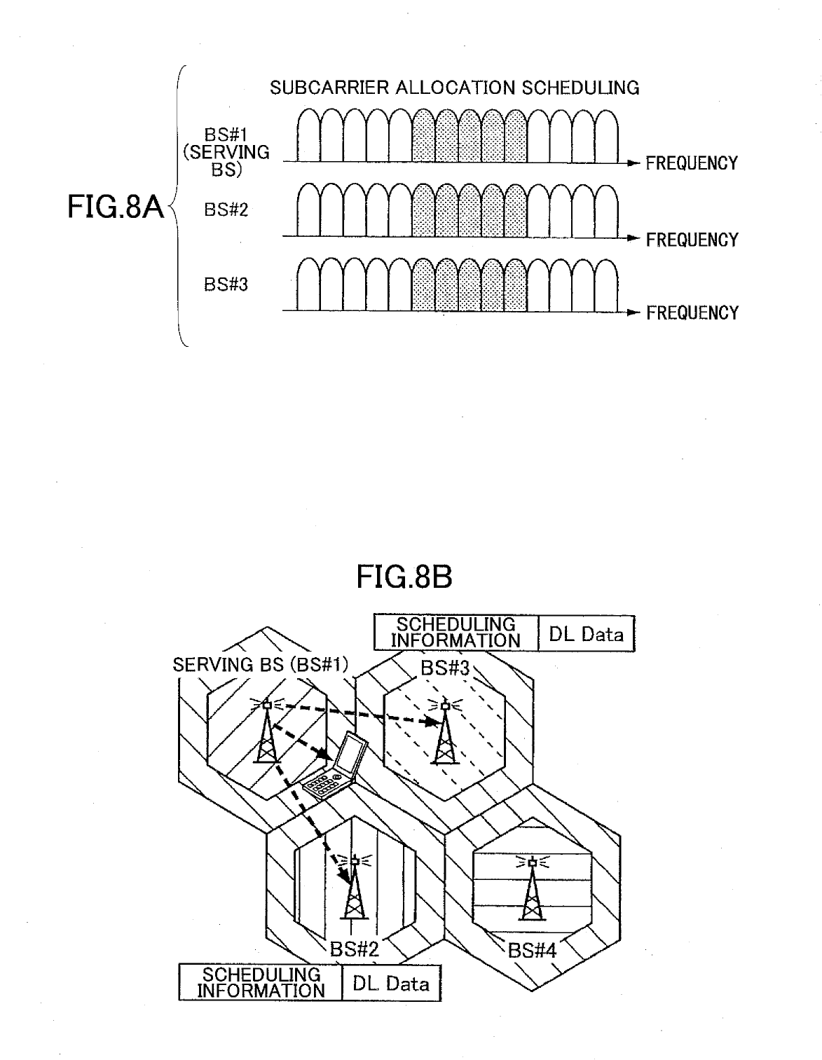

FIGS. 8A and 8B respectively are diagrams for explaining the scheduling information used in the wireless communication system illustrated in FIG. 3. As illustrated in FIG. 8B, it is assumed for the sake of convenience that the portable terminal UE is located within the second region B₁ of the serving base station apparatus BS#1. In this case, when the serving base station apparatus BS#1 makes a downlink communication to the portable terminal UE via the base station apparatuses BS#2 and BS#3 located in the neighborhood, the communication data (DL Data) is distributed to the base station apparatuses BS#2 and BS#3, and the communication data (DL Data) is sent via the base station apparatuses BS#2 and BS#3. In this state, the scheduling information, that is, the sub carrier allocation patterns, may be matched in order to match the frequency band in which the communication data (DL Data) is sent, as illustrated in FIG. 8A. The scheduling information is included within the additional header information (Additional Hdr) of the communication data (DL Data). Hence, the base station apparatuses BS#2 and BS#3 may use the additional header information (Additional Hdr) included within the communication data (DL Data) in order to match the subcarrier allocation patterns to the subcarrier allocation pattern of the serving base station apparatus BS#1.

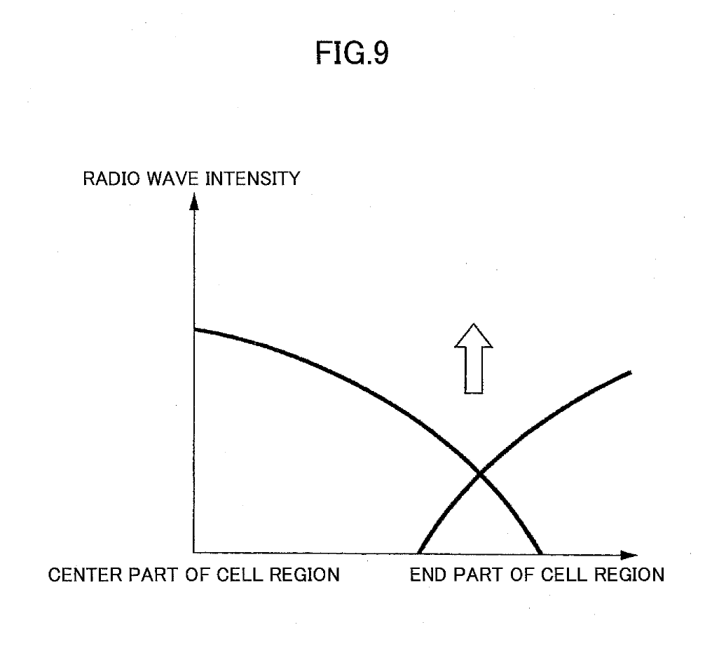

In the second regions B₁ through B₄ of the cells #1 through #4 of the wireless communication system 1 described above, the communication with a neighboring base station apparatus is performed using the second frequency band. Hence, the radio waves overlap in the second regions B₁ through B₃, and the radio wave intensity increases as illustrated in FIG. 9. FIG. 9 is a diagram for explaining the radio wave intensity at the end part of the cell region in the wireless communication system illustrated in FIG. 3. In FIG. 9, the ordinate indicates the radio wave intensity in arbitrary units, and the abscissa indicates the position within the cell region in arbitrary units. Hence, when the radio wave intensity in the second regions B₁ through B₃ is to have a level similar to that of the conventional system, the radio wave output from each base station apparatus may be reduced compared to the conventional system. In addition, when the frequency band used at the end part of the cell region differs between the adjacent cell regions in the conventional system, each base station apparatus would have a large radio wave output in order to secure a satisfactory radio wave state in the frequency band used at the end part of the cell region, but the radio wave output in the wireless communication system 1 may be sufficiently small compared to such a large radio wave output.

Moreover, the second frequency band and the physical channel used for the communication in the second regions B₁ through B₃ of the wireless communication system 1 are shared. For this reason, the communication may be positively made between a particular base station apparatus and a particular portable terminal, by including the information of the sending destination, the information of the sending source, the timing information, and the scheduling information in the communication data as the communication control information.

Furthermore, because the second frequency band is shared among the cell regions and is also shared among the portable terminals, the width of the frequency band may be made wider compared to the case in which the frequency band used at the end part of the cell region differs between the adjacent cell regions, and the communication rate and the communication capacity may be increased.

In addition, the communication between the base station apparatus and the portable terminal is performed via other neighboring base station apparatuses. Hence, each of the base station apparatus and the portable terminal may synthesize or, select one of, the communication data received via the neighboring base station apparatuses, and as a result, the communication quality may be improved. For this reason, when maintaining a communication quality similar to that of the conventional system in the wireless communication system 1, the radio wave output of each base station apparatus may be suppressed, to thereby enable reduction in the size and the power consumption of the base station apparatus.

[Downlink Communication Method]

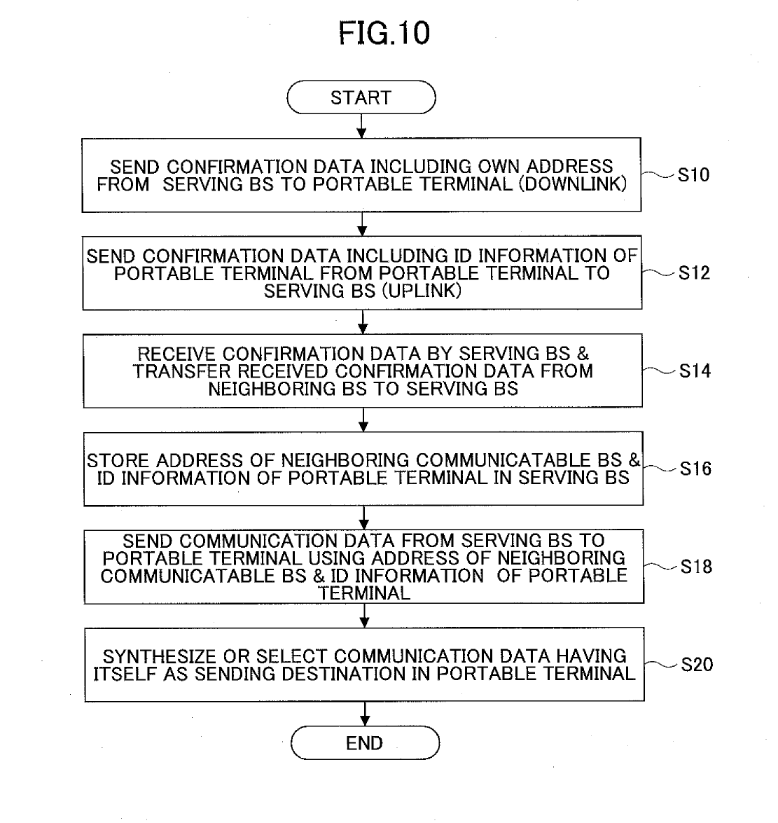

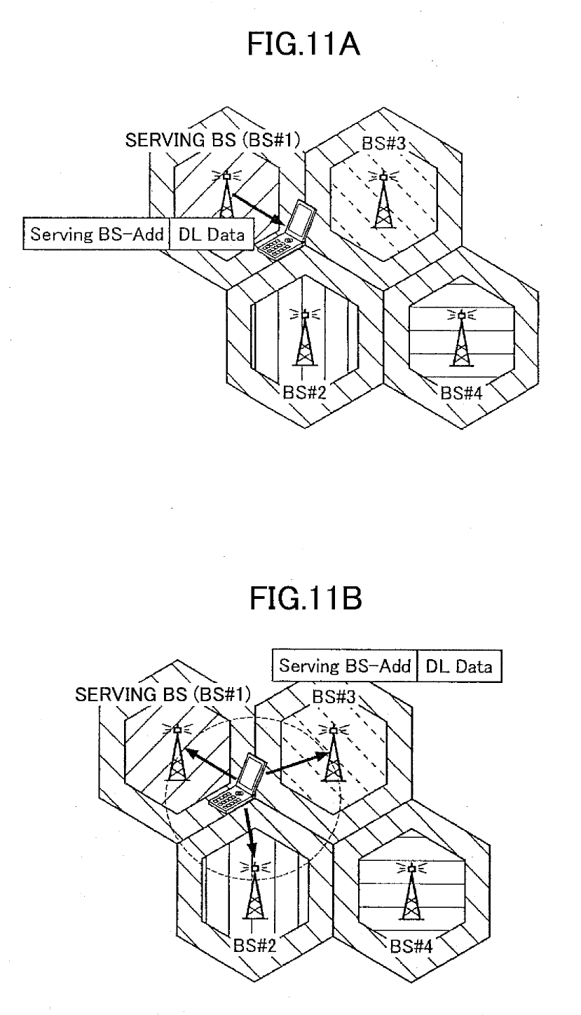

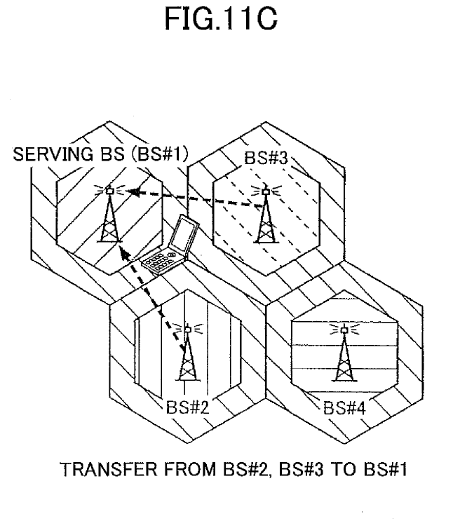

FIG. 10 is a flow chart for explaining a downlink flow between the serving base station apparatus BS#1 and the portable terminal UE in the wireless communication system illustrated in FIG. 3. In addition, FIGS. 11A through 11C respectively are diagrams for explaining an example of the downlink flow in the wireless communication system illustrated in FIG. 3.

First, after the serving base station apparatus BS#1 establishes the connection with the portable terminal UE, the serving base station apparatus BS#1 sends confirmation data to the portable terminal UE in a step S10 illustrated in FIG. 10, as illustrated in FIG. 11A. The confirmation data includes, in its additional header information, the address (Serving BS-Add) of the serving base station apparatus BS#1 together with the identification information (UE-id) of the sending destination.

Next, the portable terminal UE returns the received confirmation data having the serving base station apparatus BS#1 as the sending destination in a step S12, as illustrated in FIG. 11B. In this case, the confirmation data is returned as the communication control information. The confirmation data includes, in its additional header information, the identification information (UE-id) of the portable terminal UE at the sending source in addition to the address of the serving base station apparatus BS#1 at the sending destination.

The wireless communication part 20 of the serving base station apparatus BS#1 receives the confirmation data from the portable terminal UE, and also receives the confirmation data from the communicatable base station apparatuses BS#2 and BS#3 that are located in the neighborhood of the serving base station apparatus BS#1. As illustrated in FIG. 11C, the base station apparatuses BS#2 and BS#3 transfer the confirmation data to the serving base station apparatus BS#1 depending on the address (Serving BS-Add) of the sending destination included in the received confirmation data, in a step S14. The I-BS communication part 22 of the serving base station apparatus BS#1 receives the confirmation data from the base station apparatuses BS#2 and BS#3.

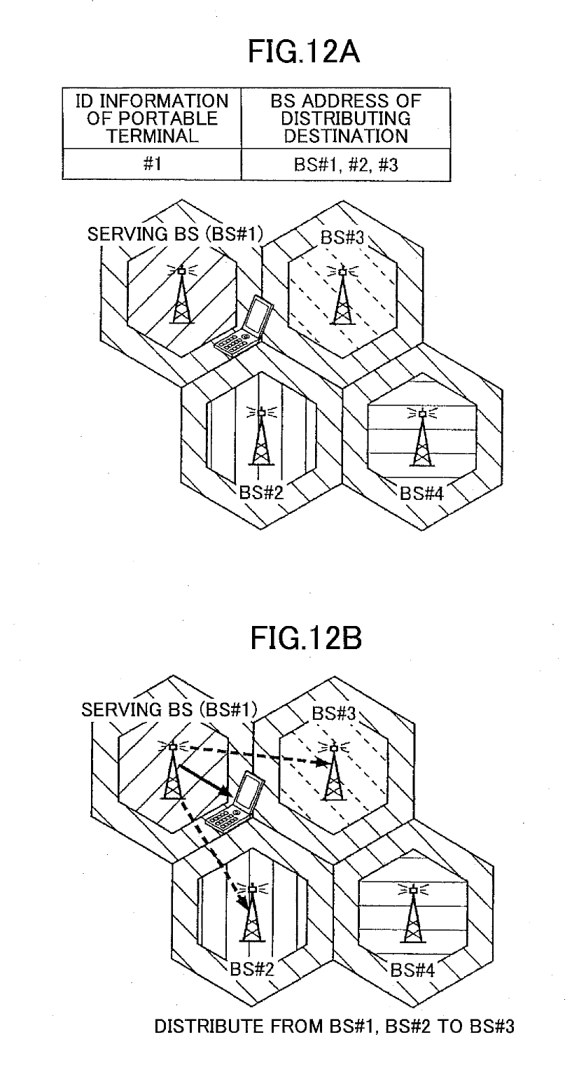

The processing part 16 of the serving base station apparatus BS#1 specifies the base station apparatuses BS#2 and BS#3 that transferred the confirmation data as the communicatable base station apparatuses, and acquires the addresses of the base station apparatuses BS#2 and BS#3 in relation to the identification information of the portable terminal UE, in addition to the address of the serving base station apparatus BS#1, and records and registers address information of the base station apparatuses BS#1, BS#2, and BS#3 at the distributing destinations in the storage part 18 in the form of a table illustrated in FIG. 12A, in a step S16. FIGS. 12A and 12B respectively are diagrams for explaining another example of the downlink flow in the wireless communication system illustrated in FIG. 3.

Next, the serving base station apparatus BS#1 uses the address information of the communicatable base station apparatuses BS#2 and BS#3 and the identification information of the portable terminal UE, to send the communication data at least including such information to the portable terminal UE, in a step S18. In this case, the communication data includes, in addition to the identification information (Serving BS-Add) of the sending source and the identification information (UE-id) of the sending destination, the timing information and the scheduling information, as the communication control information, in the additional header information (Additional Hdr). Hence, as illustrated in FIG. 12B, the communication data is send by wireless from the wireless communication part 20 to the portable terminal UE, and in addition, the communication data distributed to the communicatable base station apparatuses BS#2 and BS#3 recorded in the table is sent from the communicatable base station apparatuses BS#2 and BS#3 to the portable terminal UE. In this case, the communication data includes the timing information and the scheduling information as the communication control information, and thus, the communication data may be sent by matching the send timings and the subcarrier allocation patterns of the base station apparatuses BS#1, BS#2, and BS#3 using the timing information and the scheduling information.

The wireless communication part 48 of the portable terminal UE receives the communication data from the serving base station apparatus BS#1 and from the base station apparatuses BS#2 and BS#3. The data processing part 44 of the portable terminal UE uses the identification information of the sending destination, within the communication control information included as the additional header information of the communication data, in order to determine whether the received communication data has the portable terminal UE itself as the sending destination. When the communication data has the portable terminal UE itself as the sending destination, the data processing part 44 synthesizes or, selects one of, the communication data transferred from the base station apparatuses BS#2 and BS#3 and the communication data received from the serving base station apparatus BS#1, in a step S20. One example of the synthesizing method may perform a weighting on the communication data using an inverse number of the reception power level or the error rate. On the other hand, one example of the selecting method may select one of the communication data sent first, the communication data having a highest reception power level, and the communication data having a lowest error rate.

The wireless communication system 1 may utilize the conventional protocol in order to prevent reversal of the order and generation of overlap of the communication data sent in the form of packet data. Hence, when synthesizing (or combining) a plurality of communication data, the wireless communication system 1 may guarantee the order of the communication data and may prevent overlap of the communication data.

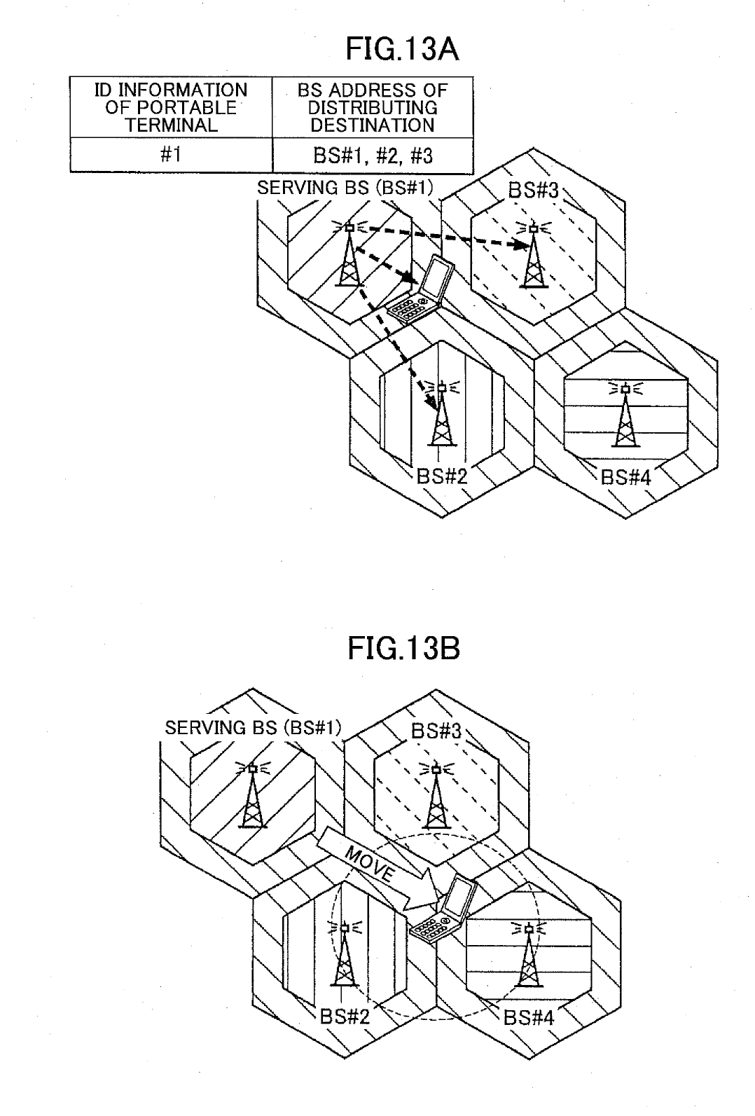

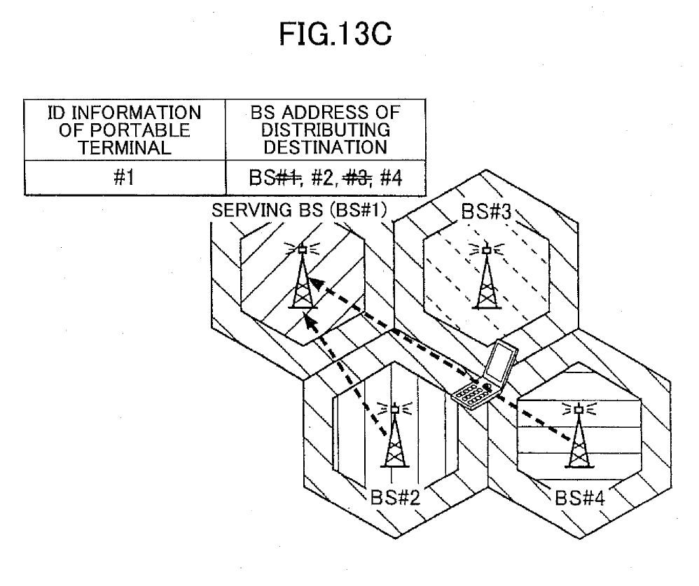

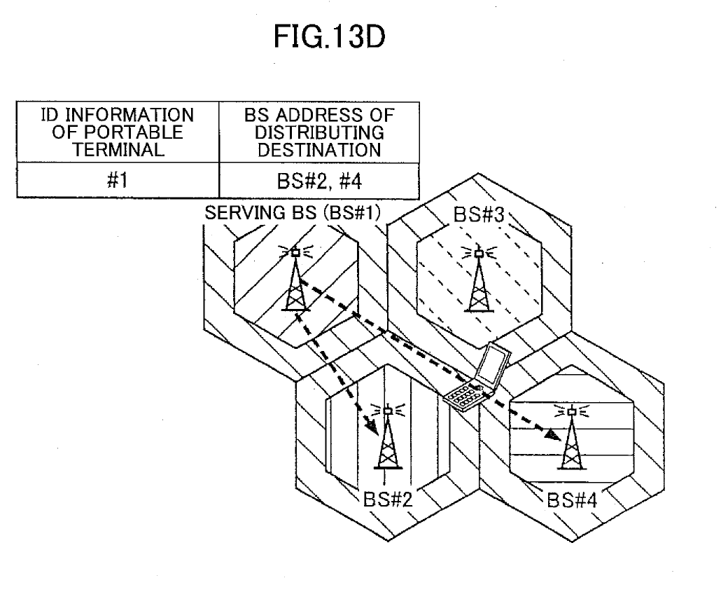

FIGS. 13A through 13D respectively are diagrams for explaining a change in a distributing destination of the communication data in the wireless communication system illustrated in FIG. 3. When the portable terminal UE moves, the base station apparatus at the distributing destination to which the serving base station apparatus BS#1 distributes the communication data changes.

As illustrated in FIG. 13A, the communication data is sent from the serving base station apparatus BS#1, and the communication data is further sent from the base station apparatuses BS#2 and BS#3 at the distributing destinations. In this case, the identification information of the portable terminal UE, the address of the serving base station apparatus BS#1, and the addresses of the base station apparatuses BS#2 and BS#3 at the distributing destinations are registered in the table within the storage part 18. The registered information in the table within the storage part 18 may be used when sending the communication data. Before the addresses of the base station apparatuses BS#2 and BS#3 at the distributing destinations are registered in the table within the storage part 18, only the address of the serving base station apparatus BS#1 is registered as the address of the base station apparatus at the distributing destination.

Suppose that the portable terminal UE moves in a boundary part between the base station apparatuses BS#2 and BS#3, as illustrated in FIG. 13B. In this case, the base station apparatus BS#3 becomes non-communicatable, however, the base station apparatus BS#4 newly becomes communicatable. Accordingly, the base station apparatus BS#4 transfers the confirmation data to the serving base station apparatus BS#1 based on the address of the serving base station apparatus BS#1 within the confirmation data sent from the portable terminal UE. In this case, the base station apparatus BS#2 also transfers the confirmation data received from the portable terminal UE to the serving base station apparatus BS#1. Because the base station apparatuses BS#1 and BS#3 cannot receive the confirmation data in this case, the addresses of the base station apparatuses BS#1 and BS#3 are deleted (or erased) from the addresses of the communicatable base station apparatuses. As a result, the addresses of the base station apparatuses at the distributing destinations are changed to the addresses of the base station apparatuses BS#2 and BS#4, as illustrated in FIG. 13C. When deleting the address of the non-communicatable base station apparatus, the address deletion may be performed when the confirmation data is not received or is not transferred for a predetermined time. The above described process may be performed by the processing part 16. Hence, the processing part 16 of the base station apparatus BS#1 may change (or update) the address of the receivable base station apparatus or the address of the base station apparatus at the distributing destination. Thereafter, as illustrated in FIG. 13D, the base station apparatuses BS#2 and BS#4 are regarded as the distributing destinations, and the communication data is sent to the portable terminal UE.

According to the downlink communication method, when the serving base station apparatus BS#1 sends the communication data to the portable terminal UE, the communication data is distributed and sent not only to the wireless communication part 20 thereof but also to the base station apparatuses BS#2 and BS#3 located in the neighborhood. For this reason, a satisfactory communication quality may be maintained even when the portable terminal UE is located at the end part of the cell region. Furthermore, the second frequency band used for the communication is shared with the neighboring base station apparatuses BS#2 and BS#3 and with other portable terminals, and the physical channel for the communication is also shared with the neighboring base station apparatuses BS#2 and BS#3 and with other portable terminals. Therefore, the limited communication resources may be utilized efficiently.

[Uplink Communication Method]

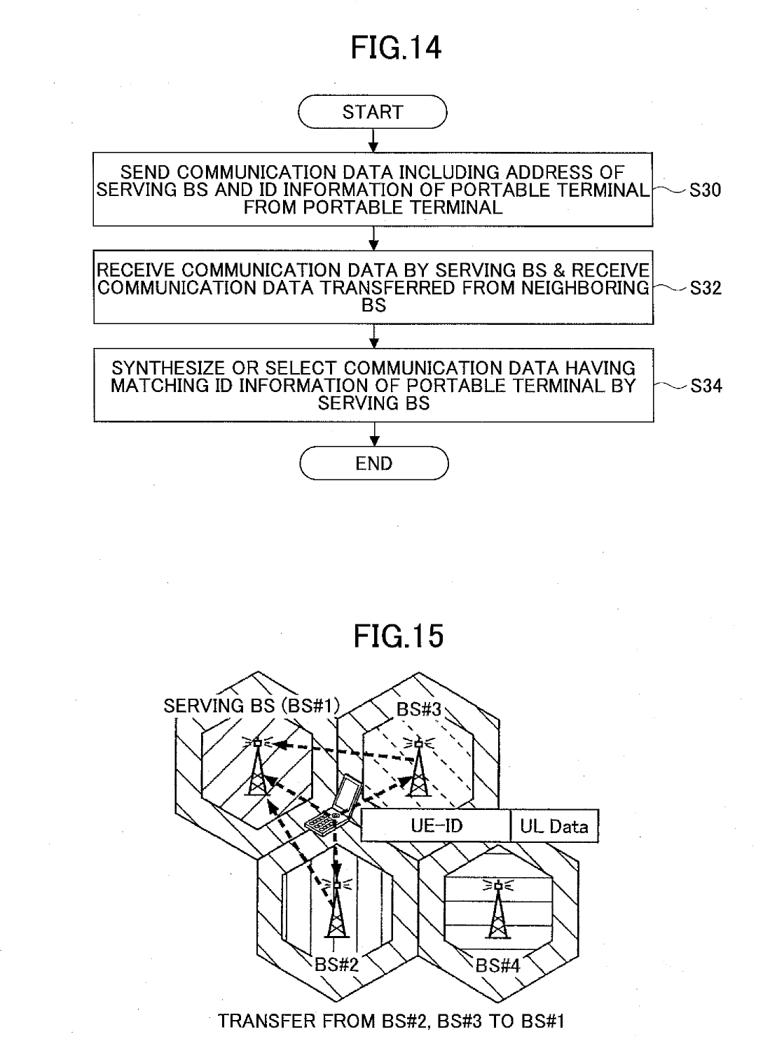

FIG. 14 is a flow chart for explaining an uplink flow between the serving base station apparatus and the portable terminal in the wireless communication system illustrated in FIG. 3. In addition, FIG. 15 is a diagram for explaining an example of the uplink flow in the wireless communication system illustrated in FIG. 3.

First, the data processing part 44 of the portable terminal UE generates the communication data including the additional header information (Additional Hdr), at least including the address (Serving BS-Add) of the serving base station apparatus BS#1 and the identification information (UE-id) of the portable terminal UE as the communication control information, and the wireless communication part 48 of the portable terminal UE sends the generated communication data, in a step S30 illustrated in FIG. 14.

In this case, as illustrated in FIG. 15, the serving base station apparatus BS#1 receives the communication data from the portable terminal UE by the wireless communication part 20, and further receives the communication data transferred via the I-BS communication part 22 from the base station apparatuses BS#2 and BS#3 communicatable with the portable terminal UE and are located in the neighborhood of the serving base station apparatus BS#1, in a step S32. The base station apparatuses BS#2 and BS#3 communicate using the second frequency band that is shared and the physical channel that is also shared therebetween, and may receive the communication data sent from the portable terminal UE. The base station apparatuses BS#2 and BS#3 transfer the communication data to the serving base station apparatus BS#1 based on the address information of the serving base station apparatus BS#1 included in the communication data as the communication control information.

Next, the processing part 16 of the serving base station apparatus BS#1 determines whether the communication data sent from the portable terminal UE or transferred to the serving base station apparatus BS#1 has the serving base station apparatus BS#1 as the sending destination, based on the communication control information included in the communication data. In addition, the processing part 16 performs a process to synthesize (or combine) or, to select one of, the communication data transferred from the base station apparatuses BS#2 and BS#3 and the communication data received by itself, when the communication data has the serving base station apparatus BS#1 as its sending destination, in a step S34. In this case, the identification information (UE-id) of the portable terminal UE included in the communication data is acquired at the same time, and thus, the communication data transferred from the base station apparatuses BS#2 and BS#3 and the communication data received by the serving base station apparatus BS#1 may be distinguished from the communication data sent from other portable terminals. One example of the synthesizing method may perform a weighting on the communication data using an inverse number of the reception power level or the error rate. On the other hand, one example of the selecting method may select one of the communication data sent first, the communication data having a highest reception power level, and the communication data having a lowest error rate.

According to the uplink communication method, when the portable terminal UE sends the communication data to the serving base station apparatus BS#1, the communication data received by the base station apparatuses BS#2 and BS#3 located in the neighborhood are transferred to the serving base station apparatus BS#1. For this reason, the serving base station apparatus BS#1 may synthesize (or combine) or, to select one of, the communication data transferred from the base station apparatuses BS#2 and BS#3 and the communication data received by the serving base station apparatus BS#1. A satisfactory communication quality may be maintained even when the portable terminal UE is located at the end part of the cell region. Moreover, the second frequency band used for the communication is shared with the neighboring base station apparatuses BS#2 and BS#3 and with other portable terminals, and the physical channel for the communication is also shared with the neighboring base station apparatuses BS#2 and BS#3 and with other portable terminals. Therefore, the limited communication resources may be utilized efficiently.

[Communication Method For When Portable Terminal Moves Across Cell Regions]

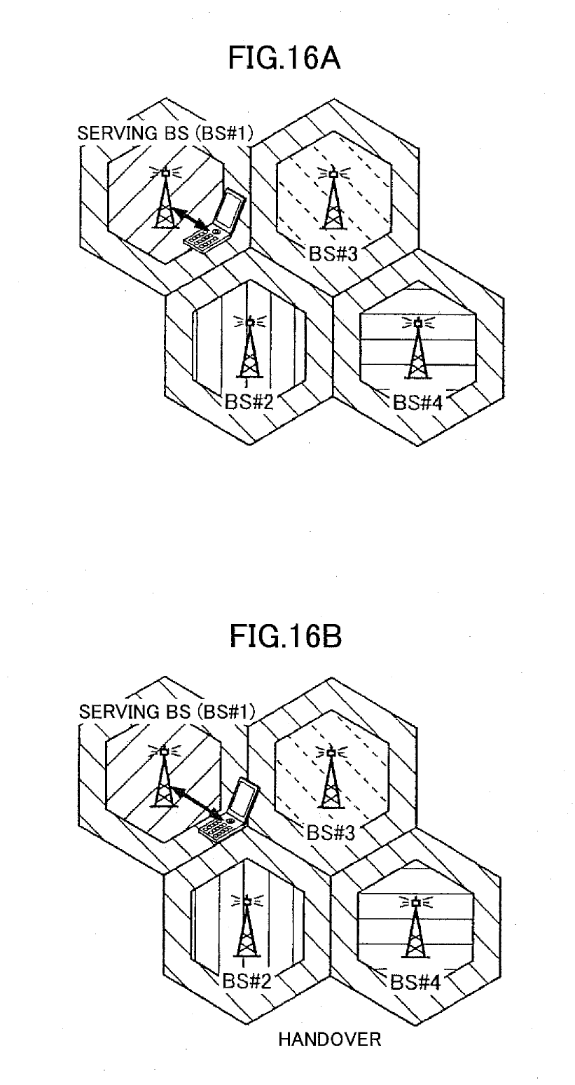

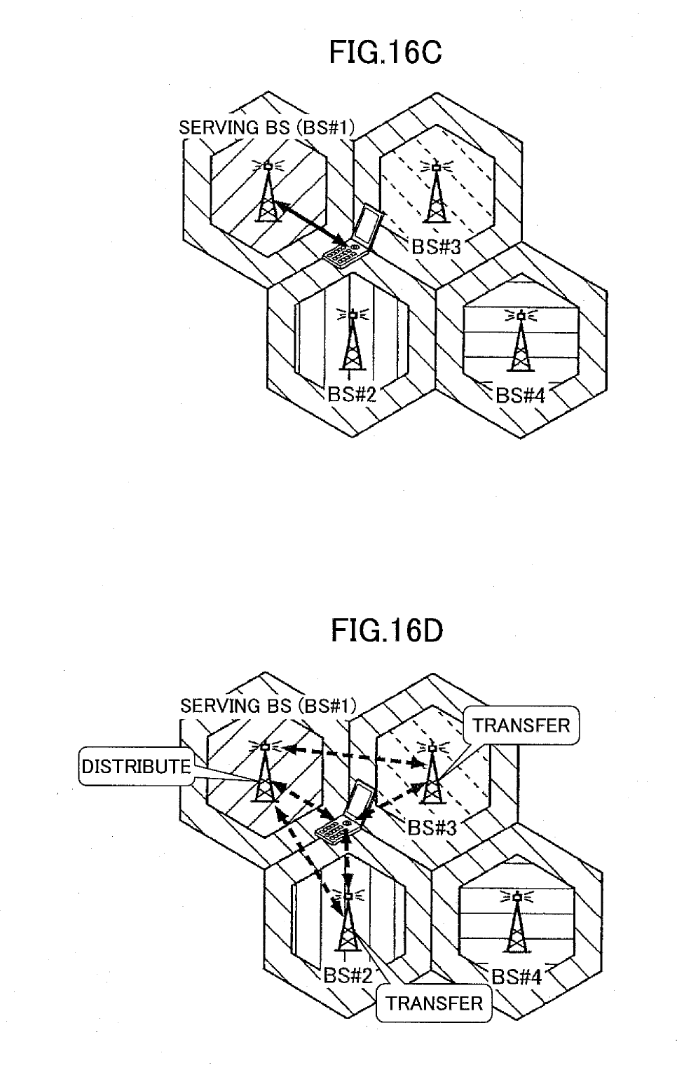

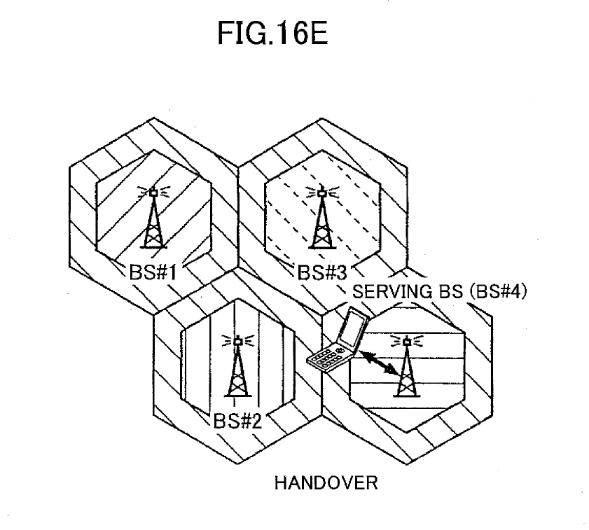

FIGS. 16A through 16E respectively are diagrams illustrating a change of the serving base station apparatus due to moving of the portable terminal in the wireless communication system illustrated in FIG. 3.

First, as illustrated in FIG. 16A, it is assumed for the sake of convenience that the portable terminal UE is located in the first region A₁ within the cell region of the serving base station apparatus BS#1. In this state, the portable terminal UE is communicatable with the serving base station apparatus BS#1. Thereafter, when the portable terminal UE moves to the second region B₁ as illustrated in FIG. 16B, the communication switches from the communication using the first frequency band to the communication using the second frequency band. In other words, a handover is performed. In this case, the serving base station apparatus BS#1 and the portable terminal UE communicate using the second frequency band, as illustrated in FIG. 16C.

When the portable terminal UE moves further within the second region B₁ and reaches the end of the cell region, the portable terminal UE becomes communicatable with the base station apparatuses BS#2 and BS#3. In the second region B₁, the second frequency band and the physical channel are shared with the base station apparatuses BS#2, BS#3, and BS#4 in addition to the serving base station apparatus BS#1. For this reason, the portable terminal UE is communicatable not only with the serving base station apparatus BS#1, but is also communicatable with base station apparatuses neighboring the serving base station apparatus BS#1. Hence, in the case of the downlink communication, the communication from the serving base station apparatus BS#1 to the portable terminal UE may be performed from the serving base station apparatus BS#1 and also via the base station apparatuses BS#2 and BS#3 at the distributing destinations, as illustrated in FIG. 16D. In addition, in the case of the uplink communication, the communication from the portable terminal UE to the serving base station apparatus BS#1 may be performed from the portable terminal UE to the serving base station apparatus BS#1 and also via the base station apparatuses BS#2 and BS#3, as illustrated in FIG. 16D.

Furthermore, when the moving portable terminal UE reaches the first region A₄ of the base station apparatus BS#4, as illustrated in FIG. 16E, the communication switches to the communication using the first frequency band that is determined within the first region A₄ of the base station apparatus BS#4, and the handover is performed. As a result, the serving base station apparatus changes from the base station apparatus BS#1 to the base station apparatus BS#4. Of course, while the transition is made from the state illustrated in FIG. 16D to the state illustrate in FIG. 16E, the base station apparatus that distributes or transfers the communication data changes depending on whether the base station apparatus is communicatable with the portable terminal UE.

The serving base station apparatus changes in the manner described above according to the portable terminal UE that moves.

In the wireless communication system 1 described above, each cell region is divided into the first region and the second region, and the frequency band used in the first region is different from the frequency band used in the second region. In the example illustrated in FIG. 3, the radio wave outputs of the base station apparatuses BS#1 through BS#4 in the first regions A₁ through A₄ are independent of the radio wave outputs in the second regions B₁ through B₄. Because the base station apparatuses BS#1 through BS#4 are respectively arranged in the first regions A₁ through A₄, the second regions B₁ through B₄ are farther away from the corresponding base station apparatuses BS#1 through BS#4 than the first regions A₁ through A₄. For this reason, the radio wave output used for the communication in the second regions B₁ through B₄ is set large compared to the radio wave output used for the communication in the first regions A₁ through A₄, by taking into account the decay by distance.

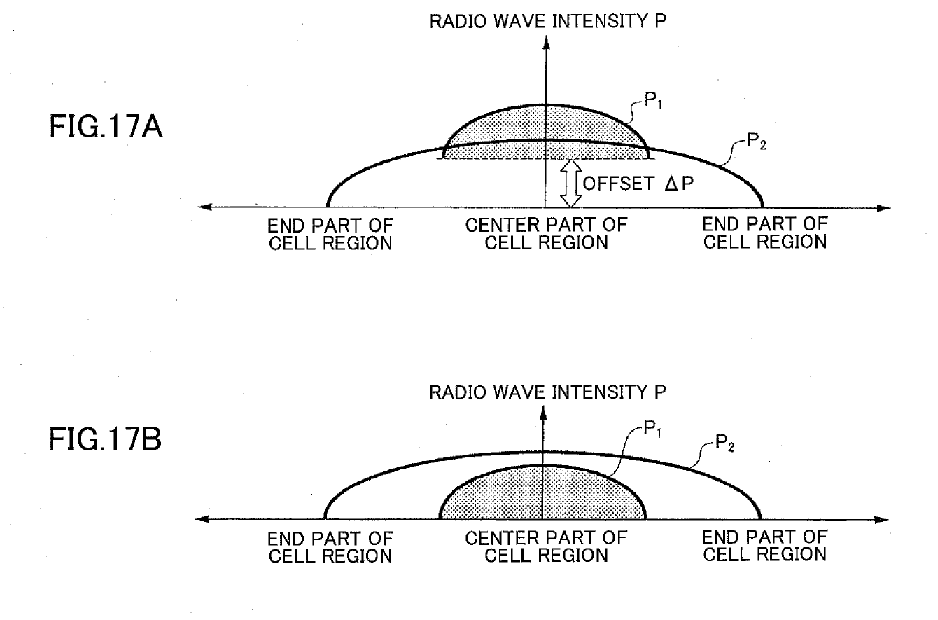

Accordingly, the portable terminal UE which checks the radio wave state of the first frequency band and the second frequency band in order to perform a smooth handover may judge the radio wave state of the second frequency band as being satisfactory even when the portable terminal UE is located in one of the first regions A₁ through A₄. In this case, the portable terminal UE may erroneously switch the communication from the first frequency band to the second frequency band. More particularly, as illustrated in FIG. 17B, the communication may erroneously switch from the communication using the first frequency band to the communication using the second frequency band, even when the portable terminal UE is located in one of the first regions A₁ through A₄, because a radio wave intensity P₁ in the first frequency band is low compared to a radio wave intensity P₂ in the second frequency band, as illustrated in FIG. 17B. FIGS. 17A and 17B respectively are diagrams for explaining the radio wave intensity in the wireless communication system illustrated in FIG. 3.

In order to prevent the erroneous handover described above, when measuring an evaluating the radio wave intensity P₁ in the first frequency band, an offset AP is provided with respect to the case in which the radio wave intensity P₂ in the second frequency band is measured and evaluated, as illustrated in FIG. 17A. Hence, the portable terminal UE and the serving base station apparatus located within one of the first regions A₁ through A₄ may positively communicate using the first frequency band.

Of course, the wireless communication system 1 may not only be used in the 3.9G mobile communication system, but may also be used in other mobile communication system, such as the 3.5G and the 4G mobile communication systems, in which the same frequency band and the same communication channel may be used in common (or shared) by a plurality of portable terminals and base station apparatuses.

Many other variations and modifications will be apparent to those skilled in the art.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A cellular wireless communication method using a plurality of base station apparatuses and a portable terminal,
wherein a cell region managed by each of the plurality of base station apparatuses includes a first region within the cell region, and a second region surrounding the first region and adjacent to another cell region that is adjacent to the cell region,
wherein the plurality of base station apparatuses use a common frequency band and a common communication channel in respective second regions when communicating with the portable terminal,
the cellular wireless communication method comprising:
generating communication data including, as communication control information, identification information of the portable terminal at a sending destination and identification information of at least one base station apparatus communicatable with the portable terminal, when an arbitrary base station apparatus amongst the plurality of base station apparatuses communicates with the portable terminal located in the second region within the cell region that is managed by the arbitrary base station apparatus;
distributing the communication data from the arbitrary base station apparatus to at least one base station apparatus communicatable with the portable terminal, depending on the communication control information;
receiving at least two communication data by the portable terminal by performing a communication between the portable terminal and the arbitrary base station apparatus and between the portable terminal and the at least one base station apparatus to which the communication data is distributed; and
processing each of the at least two communication data received by the portable terminal as data having the portable terminal as the sending destination, depending on the communication control information included in each of the at least two communication data.

2. The cellular wireless communication method as claimed in claim 1, wherein the arbitrary base station apparatus receives confirmation data including identification information of the arbitrary base station apparatus sent in advance from the portable terminal, that are transferred from a neighboring base station apparatus located in a neighborhood of the arbitrary base station apparatus, before the arbitrary base station apparatus sends the communication data to the portable terminal, to thereby specify the neighboring base station apparatus communicatable with the portable terminal and to acquire identification information of the specified neighboring base station apparatus as identification information of the base station apparatus at a distributing destination.

3. The cellular wireless communication method as claimed in claim 2, wherein the confirmation data sent from the portable terminal are data sent in advance from the arbitrary base station apparatus to the portable terminal.

4. The cellular wireless communication method as claimed in claim 1, wherein the communication control information includes, in addition to the identification information of the sending destination, at least one of timing information indicating send timings of the plurality of base station apparatuses, and scheduling information indicating subcarrier allocation information of the plurality of base station apparatuses.

5. The cellular wireless communication method as claimed in claim 4, wherein
the communication control information includes the timing information; and
the at least one base station apparatus communicatable with the portable terminal and the arbitrary base station apparatus synchronize send timings thereof when sending the communication data to the portable terminal.

6. The cellular wireless communication method as claimed in claim 4, wherein
the communication control information includes the scheduling information; and
the at least one base station apparatus communicatable with the portable terminal and the arbitrary base station apparatus match subcarrier allocation patterns thereof when sending the communication data to the portable terminal.

7. The cellular wireless communication method as claimed in claim 1, wherein each of the plurality of base station apparatuses communicate using a first frequency band within the first region of the cell region managed thereby, and communicate using a second frequency band different from the first frequency band within the second region of the cell region managed thereby.

8. The cellular wireless communication method as claimed in claim 7, wherein the first frequency band differs between two mutually adjacent cell regions.

9. A cellular wireless communication method using a plurality of base station apparatuses and a portable terminal,
wherein a cell region managed by each of the plurality of base station apparatuses includes a first region within the cell region, and a second region surrounding the first region and adjacent to another cell region that is adjacent to the cell region,
wherein the plurality of base station apparatuses use a common frequency band and a common communication channel in respective second regions when communicating with the portable terminal,
the cellular wireless communication method comprising:
sending from the portable terminal communication data including, as communication control information, identification information of an arbitrary base station apparatus managing the cell region in which the portable terminal is located, when the portable terminal is located within the second region of the cell region managed by the arbitrary base station apparatus;
receiving, by the arbitrary base station apparatus, the communication data from the portable terminal and the communication data received by and transferred from a neighboring base station apparatus located in a neighborhood of the arbitrary base station apparatus based on the communication control information; and
processing the communication data received from the portable terminal and the communication data transferred from the neighboring base station apparatus as data to be sent from the portable terminal and having the arbitrary base station apparatus as the sending destination, depending on the communication control information included in the communication data received from the portable terminal and the communication data transferred from the neighboring base station apparatus.

10. The cellular wireless communication method as claimed in claim 9, wherein the neighboring base station apparatus transfers the communication data received from the portable terminal to the arbitrary base station apparatus, when the identification information included in the communication control information is the identification information of the arbitrary base station apparatus.

11. The cellular wireless communication method as claimed in claim 9, wherein a first frequency band is used for communication in the first region, and a second frequency band different from the first frequency band is used for communication in the second region.

12. The cellular wireless communication method as claimed in claim 11, wherein the first frequency band differs between two mutually adjacent cell regions.

13. A cellular wireless communication system comprising a plurality of base station apparatuses and a portable terminal,
wherein a cell region managed by each of the plurality of base station apparatuses includes a first region within the cell region, and a second region surrounding the first region and adjacent to another cell region that is adjacent to the cell region,
wherein each of the plurality of base station apparatuses comprises:
a first communication part configured to communicate with the portable terminal using a common frequency band and a common communication channel in respective second regions of the cell regions managed by the plurality of base station apparatuses;
a first processing part configured to generate communication data including, as communication control information, identification information of the portable terminal at a sending destination and identification information of a neighboring base station apparatus located in a neighborhood of the base station apparatus managing the cell region and communicatable with the portable terminal, when the base station apparatus communicates with the portable terminal located in the second region within the cell region that is managed thereby; and
an inter-base station communication part configured to distribute the communication data to the neighboring base station apparatus communicatable with the portable terminal, depending on the communication control information,
wherein the portable terminal comprises:
a second communication part configured to receive at least two communication data by performing a communication between the portable terminal and the base station apparatus at a distributing source that distributes the communication data by the inter-base station communication part, and between the portable terminal and the neighboring base station apparatus at a distributing destination; and
a second processing part configured to process each of the at least two communication data received by the portable terminal as data having the portable terminal as the sending destination, depending on the communication control information included in each of the at least two communication data.

14. A cellular wireless communication system comprising a plurality of base station apparatuses and a portable terminal,
wherein the portable terminal comprises:
a storage part configured to store identification information of a base station apparatus that manages a cell region in which the portable terminal is located; and
a first communication part configured to send communication data including the identification information of the base station apparatus as communication control information,
wherein the cell region managed by each of the plurality of base station apparatuses includes a first region within the cell region, and a second region surrounding the first region and adjacent to another cell region that is adjacent to the cell region,
wherein each of the plurality of base station apparatuses comprises:
a second communication part configured to use a common frequency band and a common communication channel in respective second regions of the cell regions managed by the plurality of base station apparatuses when communicating with the portable terminal;
an inter-base station communication part configured to receive the communication data received by and transferred from a neighboring base station apparatus located in a neighborhood of the base station apparatus that manages the cell region based on the communication control information included in the communication data, when the portable terminal is located within the second region of the cell region managed by the base station apparatus and sends the communication data; and
a second processing part configured to process the communication data received by the second communication part and the communication data transferred from the neighboring base station apparatus and received by the inter-base station communication part, as data to be sent from the portable terminal and having the base station apparatus as a sending destination, depending on the communication control information included in the communication data received by the second communication part and the communication data received by the inter-base station communication part, when the portable terminal is located within the second region of the cell region managed by the base station apparatus and sends the communication data.

15. A base station apparatus in a cellular wireless communication system comprising a plurality of base station apparatuses and a portable terminal,
wherein a cell region managed by each of the plurality of base station apparatuses includes a first region within the cell region, and a second region surrounding the first region and adjacent to another cell region that is adjacent to the cell region,
the base station apparatuses comprising:
a communication part configured to communicate with the portable terminal using a common frequency band and a common communication channel in respective second regions of the cell regions managed by the plurality of base station apparatuses;
a processing part configured to generate communication data including, as communication control information, identification information of the portable terminal at a sending destination and identification information of a neighboring base station apparatus located in a neighborhood of the base station apparatus managing the cell region and communicatable with the portable terminal, when the base station apparatus communicates with the portable terminal located in the second region within the cell region that is managed thereby; and
an inter-base station communication part configured to distribute the communication data depending on the communication control information in order to send the communication data from the neighboring base station apparatus to the portable terminal.

16. A base station apparatus in a cellular wireless communication system comprising a plurality of base station apparatuses and a portable terminal,
wherein the cell region managed by each of the plurality of base station apparatuses includes a first region within the cell region, and a second region surrounding the first region and adjacent to another cell region that is adjacent to the cell region,
the base station apparatus comprising:
a communication part configured to use a common frequency band and a common communication channel in respective second regions of the cell regions managed by the plurality of base station apparatuses;
an inter-base station communication part configured to receive the communication data received by and transferred from a neighboring base station apparatus located in a neighborhood of the base station apparatus that manages the cell region based on the communication control information included in the communication data, when the portable terminal is located within the second region of the cell region managed by the base station apparatus and sends the communication data; and
a processing part configured to process the communication data received by the communication part and the communication data transferred from the neighboring base station apparatus and received by the inter-base station communication part, as data to be sent from the portable terminal and having the base station apparatus as a sending destination, depending on the communication control information included in the communication data received by the communication part and the communication data received by the inter-base station communication part, when the portable terminal is located within the second region of the cell region managed by the base station apparatus and sends the communication data.

17. A portable terminal in a cellular wireless communication system comprising a plurality of base station apparatuses and the portable terminal,
wherein a cell region managed by each of the plurality of base station apparatuses includes a first region within the cell region, and a second region surrounding the first region and adjacent to another cell region that is adjacent to the cell region,
wherein the plurality of base station apparatuses use a common frequency band and a common communication channel in respective second regions when communicating with the portable terminal,
the portable terminal comprising:
a communication part configured to receive using the wireless communication system, when the portable terminal is located within the second region of the cell region managed by an arbitrary base station apparatus, communication data sent from the arbitrary base station apparatus and including, as communication control information, identification information of the portable terminal at a sending destination and identification information of at least one base station apparatus communicatable with the portable terminal, and communication data, including the communication control information, distributed from the arbitrary base station apparatus to a neighboring base station apparatus located in a neighborhood of the arbitrary base station apparatus and sent from the neighboring base station apparatus; and
a processing part configured to process each of the communication data sent from the arbitrary base station apparatus and the communication data sent from the neighboring base station apparatus having the portable terminal as the sending destination, depending on the communication control information included in each of the communication data sent from the arbitrary base station apparatus and the communication data sent from the neighboring base station apparatus.

18. A portable terminal in a cellular wireless communication system comprising a plurality of base station apparatuses and the portable terminal,
wherein a cell region managed by each of the plurality of base station apparatuses includes a first region within the cell region, and a second region surrounding the first region and adjacent to another cell region that is adjacent to the cell region,
wherein the plurality of base station apparatuses use a common frequency band and a common communication channel in respective second regions when communicating with the portable terminal,
the portable terminal comprising:
a storage part configured to store identification information of an arbitrary base station apparatus that manages the cell region in which the portable terminal is located; and
a communication part configured to send, using the wireless communication system, communication data including the identification information of the arbitrary base station apparatus as communication control information to the arbitrary base station apparatus and a neighboring base station apparatus located in a neighborhood of the arbitrary base station apparatus, when the portable terminal is located in the second region of the cell region managed by the arbitrary base station apparatus.
